(19) United States
(12) Patent Application Publication
(10) Pub. No.: US 2026/0043207 A1
(43) Pub. Date: Feb. 12, 2026

(54) SHORELINE HABITATION CONSTRUCTIONS UNITS, STRUCTURES MADE THEREFROM AND USES THEREOF

(71) Applicant: THE DAVEY TREE EXPERT COMPANY, KENT, OH (US)

(72) Inventors: FREDERICK WORTH CREECH, JR., RALEIGH, NC (US); MARY-MARGARET SYKES MCKINNEY, EDENTON, NC (US)

(73) Assignee: THE DAVEY TREE EXPERT COMPANY, KENT, OH (US)

(21) Appl. No.: 19/295,080

(22) Filed: Aug. 8, 2025

Related U.S. Application Data
(60) Provisional application No. 63/681,549, filed on Aug. 9, 2024.
(60) Provisional application No. 63/709,613, filed on Oct. 21, 2024.
(60) Provisional application No. 63/766,492, filed on Mar. 4, 2025.

(51) Int. Cl. E02B 3/06; A01K 61/77; E02B 3/04; E02B 3/14

(52) U.S. Cl. CPC E02B 3/06; A01K 61/77; E02B 3/046; E02B 3/14

(57) ABSTRACT

A construction unit for construction of eco-friendly structures in a body of water is provided, wherein the construction unit is formed from at least a cementitious material, wherein the construction unit forms a rectangular prism having two or more extensions extending from a long face of the rectangular prism, wherein a first two of the two or more extensions are located at opposite ends of the long face of the rectangular prism, and, when present, additional extensions are located between the first two of the plurality of extensions, along with structures formed from the construction unit and methods for making the construction unit.

### CROSS REFERENCE TO RELATED APPLICATIONS

The present application is related to, and claims priority to, each of U.S. Provisional Application Ser. No. 63/681,549, filed Aug. 9, 2024, pending; U.S. Provisional Application Ser. No. 63/709,613, filed Oct. 21, 2024, pending; and U.S. Provisional Application Ser. No. 63/766,492, filed Mar. 4, 2025, pending, the contents of each of which are incorporated herein by reference in their entireties.

### BACKGROUND OF THE INVENTION

### Field of the Invention

The present invention relates to living shorelines comprising shoreline habitation construction units that are designed to be used to construct a variety of structures used to stabilize a shoreline, construct revetments, and provide a place for aquatic life to thrive.

### Description of the Related Art

A living shoreline is a natural approach to coastal erosion control and habitat restoration that may utilizes a combination of native vegetation, sand, rocks, and other organic materials to stabilize the shoreline. Unlike traditional hard structures like seawalls or bulkheads, living shorelines work with natural processes to provide protection against erosion while also promoting biodiversity and enhancing ecosystem services. Living shorelines may provide habitat for various species of fish, birds, and other wildlife, contributing to the overall health and resilience of coastal ecosystems. These natural features also improve water quality by filtering pollutants and sediment from runoff before they reach the ocean. Furthermore, the use of living shorelines may aid in wave attenuation playing a crucial role in protecting the shoreline from erosion and mitigating the impacts of coastal storms. Overall, living shorelines offer a sustainable and environmentally friendly alternative to traditional shoreline stabilization methods, providing both ecological benefits and effective erosion control solutions.

The typical depth of a living shoreline varies based on factors like tidal range, wave energy, and local coastal conditions. Generally, living shorelines are implemented in shallow water areas, ranging from intertidal zones to shallow subtidal areas. Intertidal zones, found between high and low tidemarks, are often targeted for living shoreline projects due to their suitability for vegetation like marsh grasses and mangroves, which stabilize sediments and reduce wave energy while providing habitat. Shallow subtidal areas, slightly deeper but still submerged even during low tide, can also host living shorelines with features like submerged aquatic vegetation or oyster reefs, contributing to habitat enhancement and wave attenuation. However, living shorelines in these shallow areas may be susceptible to displacement or erosion in response to high wave energy. High wave energy can exert considerable force on the vegetation and substrate of living shorelines, potentially causing erosion or displacement, especially if the vegetation and substrate are not well suited to withstand local wave conditions or if they are inadequately anchored or stabilized. Many living shoreline installations require regular monitoring and maintenance essential to mitigate the risk of displacement and ensure their long-term stability in protecting coastal areas from erosion and promoting habitat restoration.

### SUMMARY OF THE INVENTION

One object of the present invention is to provide an economical solution to construct revetments, artificial reefs, shore stabilization, wave attenuation, and other semi-aquatic ecological restoration constructions.

A further object of the present invention is to provide a construction unit that can be assembled in a variety of different configurations resulting in shoreline habitation units.

Another object of the present invention is to provide a method for making the shoreline habitation units of various sizes according to their construction requirements.

Another object of the present invention is to provide a construction unit that is of a size suitable for handling and installation by an individual without the need for heavy machinery or other equipment.

These and other objects and advantages of the invention, either alone or in combinations thereof, may be satisfied by a construction unit for construction of eco-friendly structures in a body of water comprising:
a cementitious material, preferably a cementitious material comprising a primarily calcium carbonate material; and a cement that is capable of holding the primarily calcium carbonate material;
wherein the construction unit comprises a rectangular prism having two or more extensions extending from one long face of the rectangular prism, wherein a first two of the two or more extensions are located at opposite ends of the long face of the rectangular prism, and, when present, additional extensions are located between the first two of the plurality of extensions, wherein a plurality of the construction units can be configured to construct revetments, sills of various heights, artificial reefs, shore stabilization structures, wave attenuation structures, living shoreline habitats, and other semi-aquatic ecological restoration constructions, wherein the construction unit is preferably of a size and weight suitable for handling and installation by an individual without the need for heavy machinery or other equipment.

The foregoing and other features of the application are described below with reference to the drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a side view of one embodiment of a construction unit of the present invention.

FIG. 2 shows a perspective top/side view of the embodiment of a construction unit of FIG. 1.

FIG. 3 shows a perspective bottom/side view of one embodiment of a construction unit of FIG. 1.

FIG. 4 shows an end view of one embodiment of a construction unit of FIG. 1.

FIG. 5 shows a top view of one embodiment of a construction unit of FIG. 1.

FIG. 6 shows a perspective top/side view of one embodiment of a low sill configuration assembled form a plurality of construction units of one embodiment of the present invention as depicted in FIGS. 1-5.

FIG. 7 shows an exploded perspective top/side view of the embodiment of low sill configuration of FIG. 6.

FIG. 8 shows a top view of the embodiment of low sill configuration of FIG. 6.

FIG. 9 shows a bottom view of the embodiment of low sill configuration of FIG. 6.

FIG. 10 shows an exploded side view of the embodiment of low sill configuration of FIG. 6.

FIG. 11 shows a front view of the embodiment of low sill configuration of FIG. 6.

FIG. 12 shows a left side view of the embodiment of low sill configuration of FIG. 6.

FIG. 13 shows a right side view of the embodiment of low sill configuration of FIG. 6.

FIG. 14 shows a perspective top/side view of an embodiment of a high sill configuration assembled form a plurality of construction units of one embodiment of the present invention as depicted in FIGS. 1-5.

FIG. 15 shows an exploded perspective top/side view of the embodiment of high sill configuration of FIG. 14.

FIG. 16 shows a top view of the embodiment of high sill configuration of FIG. 14.

FIG. 17 shows a bottom view of the embodiment of high sill configuration of FIG. 14.

FIG. 18 shows an exploded side view of the embodiment of high sill configuration of FIG. 14.

FIG. 19 shows a front view of the embodiment of high sill configuration of FIG. 14.

FIG. 20 shows a left side view of the embodiment of high sill configuration of FIG. 14.

FIG. 21 shows a right side view of the embodiment of high sill configuration of FIG. 14.

FIG. 22 shows a perspective top/side view of an embodiment of a box habitation unit configuration assembled from a plurality of construction units of one embodiment of the present invention as depicted in FIGS. 1-5.

FIG. 23 shows an exploded perspective top/side view of the box habitation unit of FIG. 22.

FIG. 24 shows a top view of the embodiment of the box habitation unit of FIG. 22.

FIG. 25 shows a bottom view of the embodiment of the box habitation unit of FIG. 22.

FIG. 26 shows an exploded side view of the embodiment of the box habitation unit of FIG. 22.

FIG. 27 shows a view of the front (and back) of the embodiment of the box habitation unit of FIG. 22.

FIG. 28 shows a view of the left (and right) side of the embodiment of the box habitation unit of FIG. 22.

FIG. 29 shows a perspective top/side view of an embodiment of the construction unit of FIG. 2 having the top face (12) being a textured surface formed of the primarily calcium carbonate materials.

FIG. 30 shows a side view of the embodiment of construction unit of FIG. 29.

FIG. 31 shows a side view of another embodiment of a construction unit of the present invention.

FIG. 32 shows a perspective top/side view of the embodiment of a construction unit of FIG. 31.

FIG. 33 shows a perspective bottom/side view of one embodiment of a construction unit of FIG. 31.

FIG. 34 shows an end view of one embodiment of a construction unit of FIG. 31.

FIG. 35 shows a top view of one embodiment of a construction unit of FIG. 31.

FIG. 36 shows a perspective top/side view of one embodiment of a low sill configuration assembled from a plurality of construction units of one embodiment of the present invention as depicted in FIGS. 31-35.

FIG. 37 shows a perspective top/side view of an embodiment of a high sill configuration assembled from a plurality of construction units of one embodiment of the present invention as depicted in FIGS. 31-35.

FIG. 38 shows a perspective top/side view of an embodiment of a box habitation unit configuration assembled from a plurality of construction units of one embodiment of the present invention as depicted in FIGS. 31-35.

FIG. 39 shows a perspective top/side view of a habitat structure (800) according to one embodiment of the invention.

FIG. 40 shows a front view of the habitat structure (800) of one embodiment of the invention as depicted in FIG. 39.

FIG. 41 shows a top view of the habitat structure (800) of one embodiment of the invention as depicted in FIG. 39.

FIG. 42 shows a bottom view of the habitat structure (800) of one embodiment of the invention, in which it is easier to see the horizontal support structures (820) that form a part of base structure (810) as depicted in FIG. 39.

FIG. 43 shows an exploded front or rear view of the habitat structure (800) of one embodiment of the invention as depicted in FIG. 39.

FIG. 44 shows an exploded right or left side view of the habitat structure (800) of one embodiment of the present invention as depicted in FIG. 39.

FIG. 45 shows a side view of one embodiment of the base structure (810) and vertical support structure (830) having one or more stabilizing structures (870) extending from the sides thereof.

### DETAILED DESCRIPTION OF THE PREFERRED EMBODIMENTS

The terms “about”and “essentially”mean ±10 percent.

The terms “a” or “an,” as used herein, are defined as one or as more than one. The term “plurality,” as used herein, is defined as two or as more than two. The term “another,” as used herein, is defined as at least a second or more. The terms “including”
and/or “having,”as used herein, are defined as comprising (i.e., open language).

The term “coupled,” as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments,” “an embodiment”, “an implementation” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

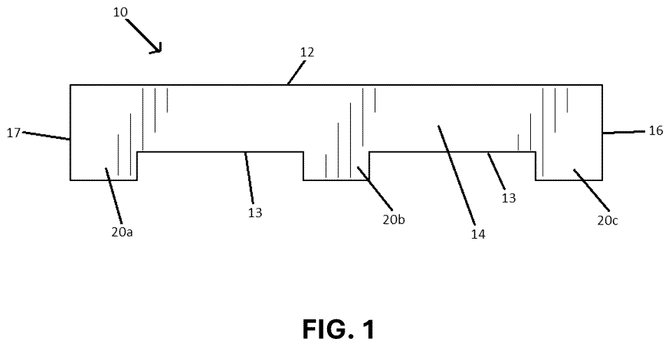

As used herein, the term “construction unit” (10) refers to a solid piece of a cementitious material. As used herein, the term “cementitious material” includes a variety of materials, such as cement, concrete, fiber cement, and other suitably rigid cement containing materials. Preferably the cementitious material is eco-friendly to enable the attachment of wildlife, such as oysters and other sea based animals. In certain embodiments of the present invention, the cementitious material comprises a plurality of primarily calcium carbonate material held together with cement and in one embodiment, with a bio-cement. FIG. 1 shows a side view of one preferred embodiment of the construction unit of the invention, in which the construction unit (10) has a top face (12), a bottom face (13), a front face (14), and a back face (15, not shown), two end faces (16 and 17) and two or more extensions, three in the preferred embodiment shown in FIG. 1 (20a, 20b, and 20c). It is noted that while the terminology “top face”, “bottom face”, “front face” and “back face” are used herein, these terms are merely intended to differentiate between sides of the construction unit (10). The construction unit (10) can be placed in any desired orientation when using it to build structures, so that any side is on “top” or “bottom” in its final assembled structure.

While the construction units (10) can be any size, they are preferably of a size and weight suitable for handling and installation by an individual without the need for heavy machinery or other equipment. The construction unit (10) may preferably have a length from end face (16) to end face (17) ranging from 24 inches to 36 inches. The construction unit (10) may preferably have a thickness from front face (14) to back face (15) of from 3 inches to 6 inches. The construction unit (10) may preferably have a weight from 25 to 50 pounds.

The construction unit (10) may preferably have a height from top face (12) to bottom face (13) (not including the extensions 20a, 20b, and 20c) of from 3 inches to 6 inches. The total height of the construction unit (10) including the extensions (20a, 20b, and 20c) may preferably be from 6 to 12 inches. Of course, depending on the size of ultimate assembly to be prepared, the size of the construction unit (10) can be scaled as desired, with larger units requiring machinery of various types to handle and install. Larger scale construction units (10) can be prepared and used to construct assemblies for installation in much deeper water environments

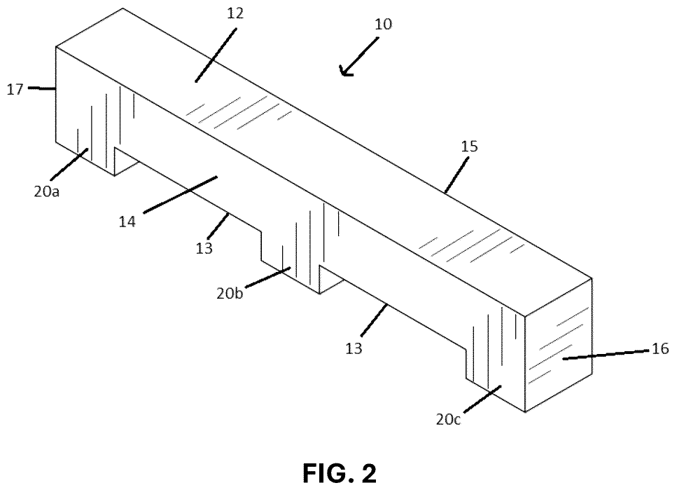

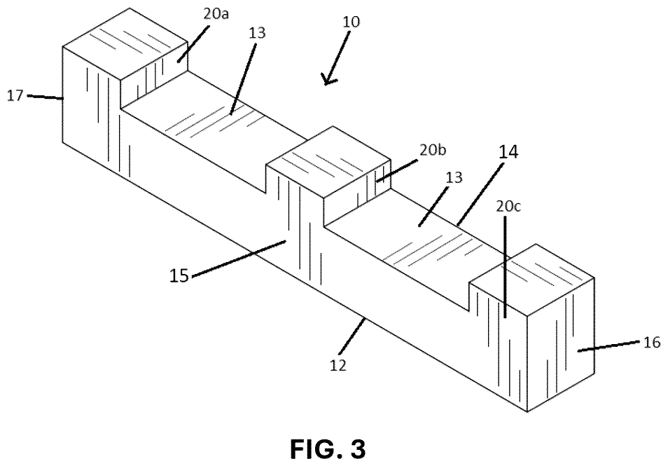

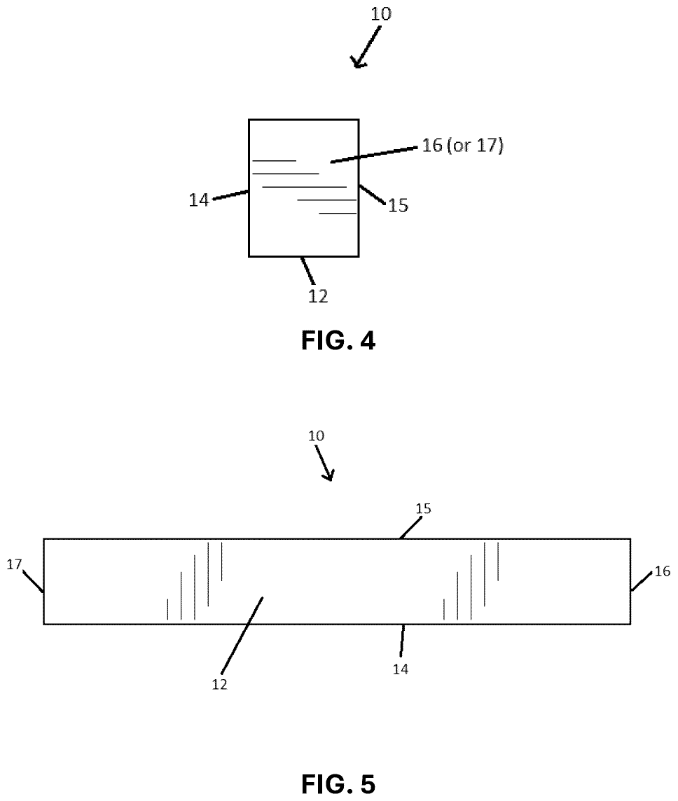

FIG. 2 shows a perspective top/side view of the embodiment of the embodiment of construction unit of FIG. 1. FIG. 3 shows a perspective bottom/side view of the embodiment of construction unit of FIG. 1. FIG. 4 shows an end view of the embodiment of construction unit of FIG. 1. FIG. 5 shows a top view of the embodiment of construction unit of FIG. 1.

The construction unit (10) comprises two or more extensions (20a-20c) extending from the bottom face (13) which act in multiple capacities. In one preferred embodiment of the construction unit (10) of the present invention, there are three extensions (20a, 20b, 20c) with two (20a and 20c) extending from the bottom face (13) at each of the ends of the construction unit (10), and the third (20b) extending from the bottom face (13) at the middle of the construction unit (10). If there are more than three such extensions, the third, fourth, etc extensions are preferably spaced approximately evenly extending from the bottom face (13) between the first two extensions (20a) and (20c) located at the ends. This arrangement of extensions from one face (here called the bottom face (13)) permits a plurality of the construction units (10) to be assembled in a variety of structures, including but not limited to, those detailed further below.

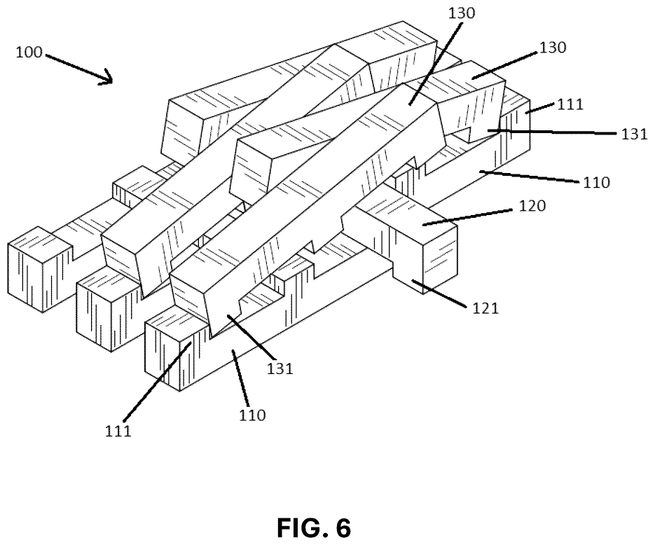

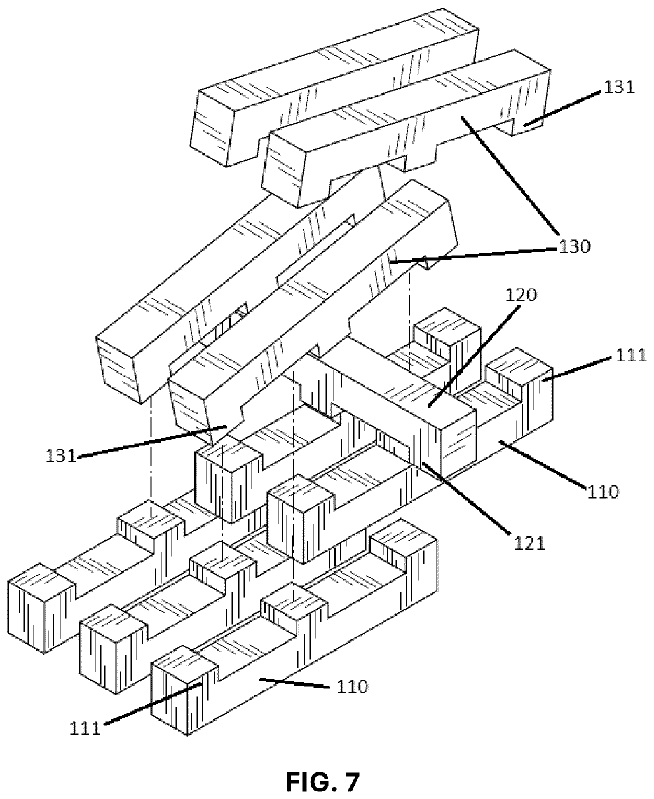

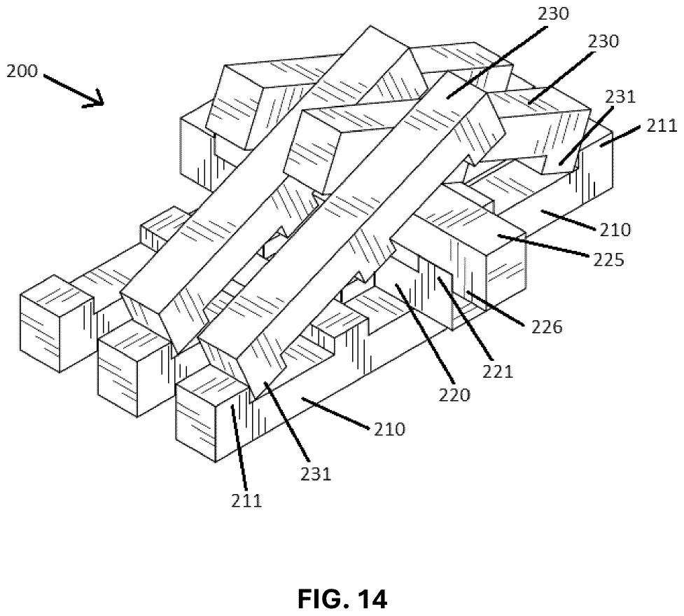

The construction units of the present invention can be used to build a variety of structures useful in the protection of shoreline habitats and aquaculture. For example, and not intended to be limiting, a plurality of the construction units can be configured to construct revetments, sills of various heights, artificial reefs, shore stabilization structures, wave attenuation structures, living shoreline habitats, and other semi-aquatic ecological restoration constructions. The structures that can be assembled using a plurality of construction units of the present invention is limited only by the imagination of the person building the structure. By way of examples, FIGS. 6-13 provide views of an embodiment of a lower height sill structure formed from a plurality of construction units (10) of FIGS. 1-5; FIGS. 14-21 provide views of an embodiment of a higher height sill structure formed from a plurality of construction units (10) of FIGS. 1-5; and FIGS. 22-28 provide views of an embodiment of a simple shoreline habitation structure formed from a plurality of construction units (10) of FIGS. 1-5.

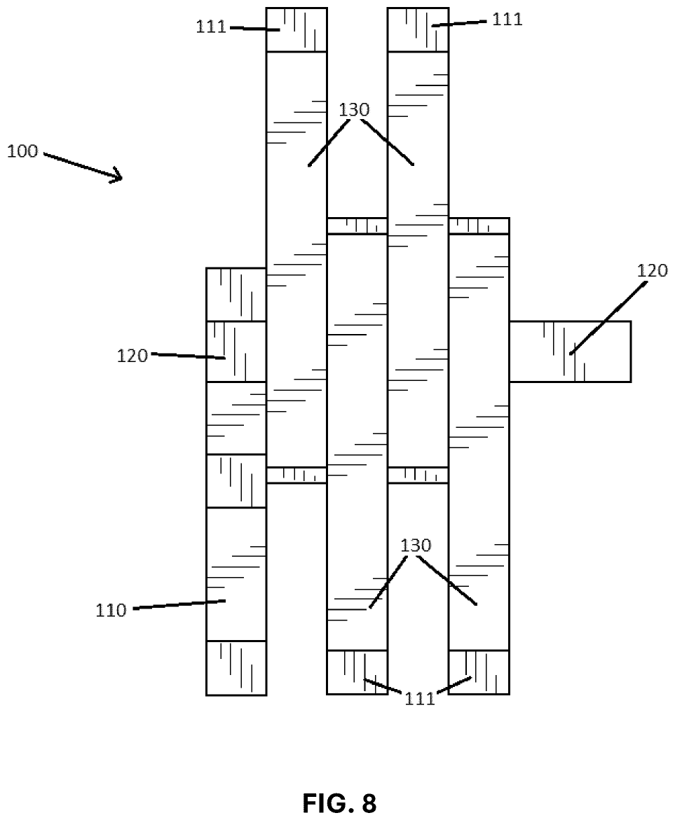

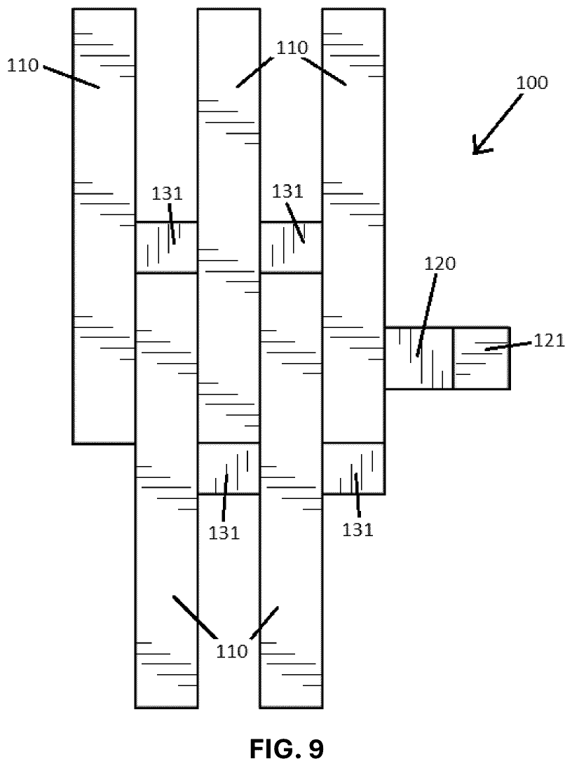

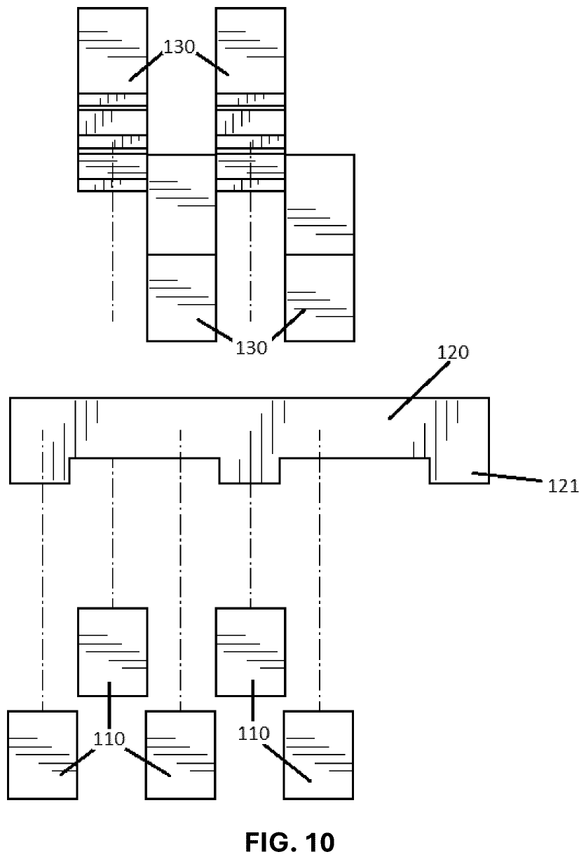

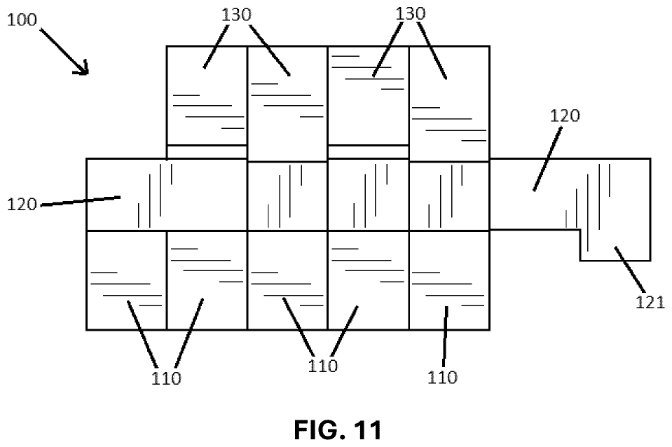

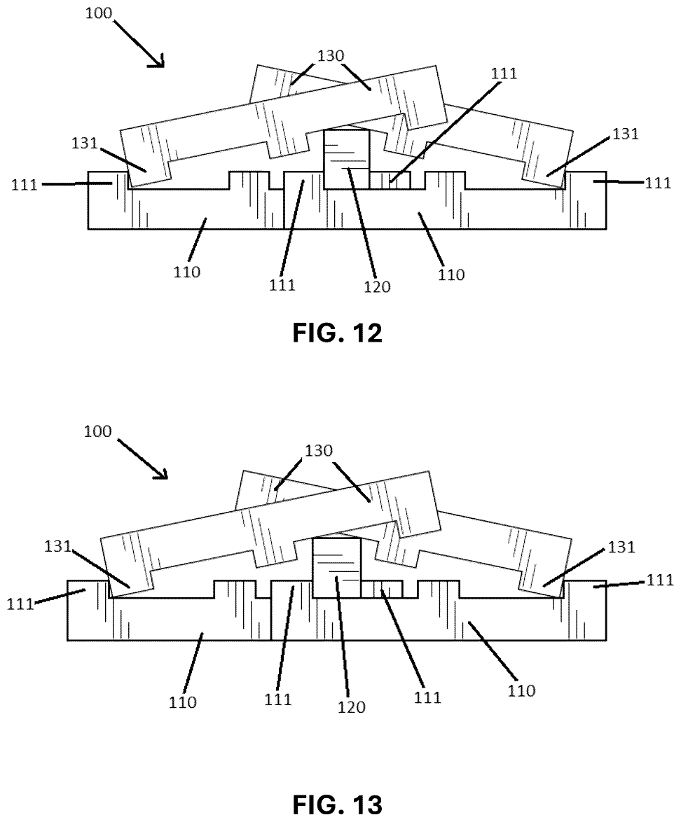

In one embodiment, the construction units of the present invention can be used to construct an artificial aquatic sill structure. An aquatic sills (sometimes called oceanic sill) is a sea floor barrier of relatively shallow depth that restricts water movement between zones of an oceanic basin or lake bottom. A plurality of the construction units of the present invention can be assembled into artificial sill structures of varying heights. FIGS. 6-13 provide various views of one embodiment of the construction of a lower height sill (100) formed from a plurality of construction units of the present invention (as depicted individually in FIGS. 1-5). FIG. 6 provides a perspective top/side view of this embodiment of lower height sill structure (100). In this embodiment, the depicted section of the lower height sill (100) is formed from base units (110) arranged substantially parallel to one another and overlapping at one end with base units (110) protruding in the opposite direction, with all of the extensions (111) of the base units (110) directed in an upward direction. The ends of the alternately directed base units (110) overlap sufficiently that a support unit (120) can be placed perpendicular to the base units (110) on top thereof, with the extensions (121) pointing in a downward direction, such that the support unit (120) sits on top of or between the extensions at adjacent ends of the alternating base units (110). Top units (130) are then placed with the extensions (131) pointing in a downward direction, such that one end rests on a base unit (110) abutted against an extension (111), and the other end rests on the support unit (120) in an alternating fashion according to the arrangement of the base units (110). FIG. 7 shows an exploded oblique top/side view of the embodiment of sill configuration of FIG. 6. FIG. 8 shows a top view of the embodiment of sill configuration of FIG. 6. FIG. 9 shows a bottom view of the embodiment of sill configuration of FIG. 6. FIG. 10 shows an exploded side view of the embodiment of sill configuration of FIG. 6. FIG. 11 shows a front view of the embodiment of sill configuration of FIG. 6. FIG. 12 shows a left side view of the embodiment of sill configuration of FIG. 6. FIG. 13 shows a right side view of the embodiment of sill configuration of FIG. 6.

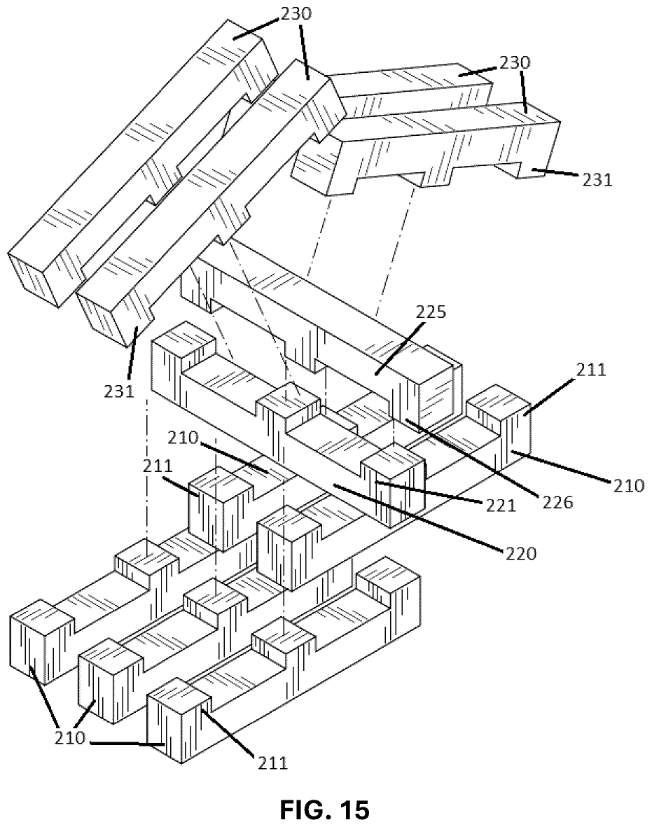

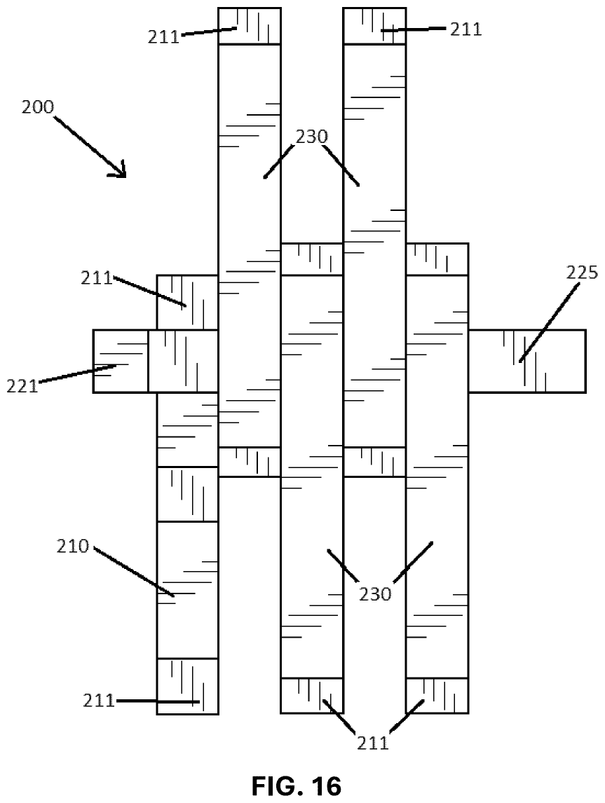

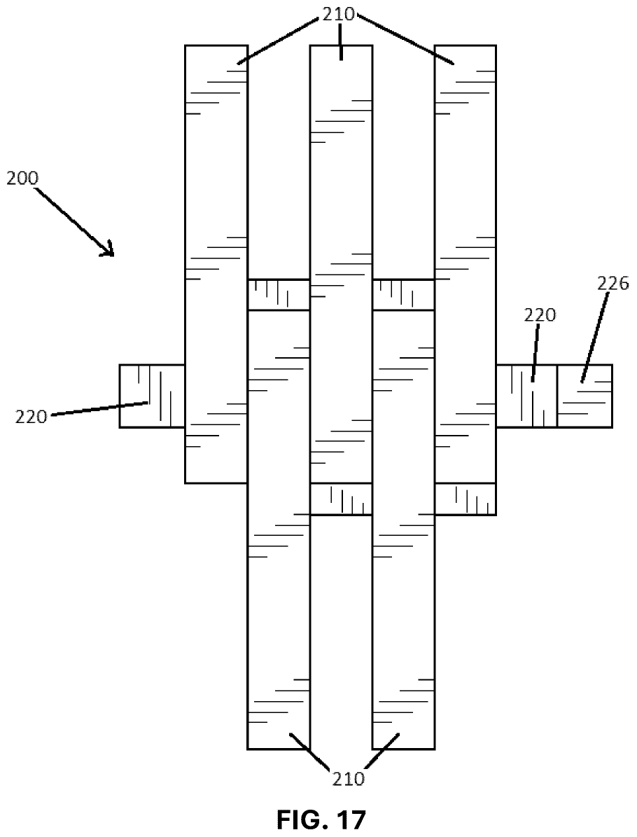

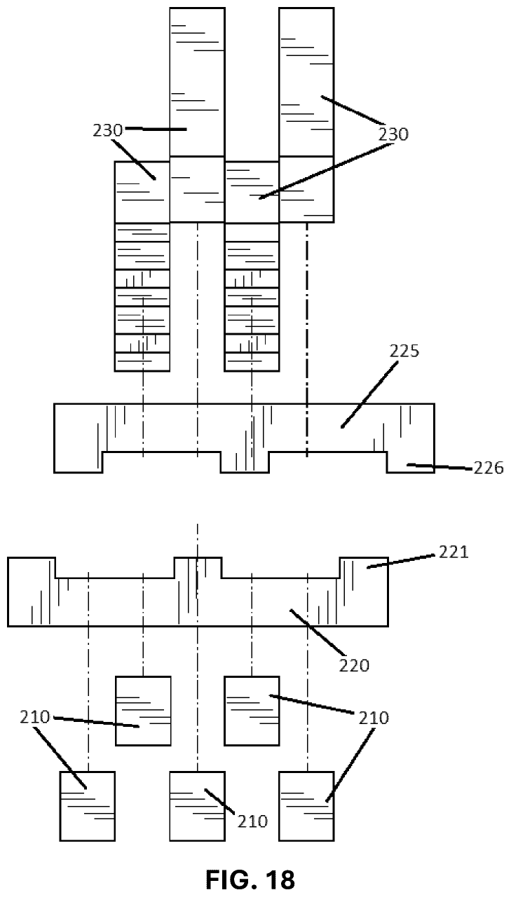

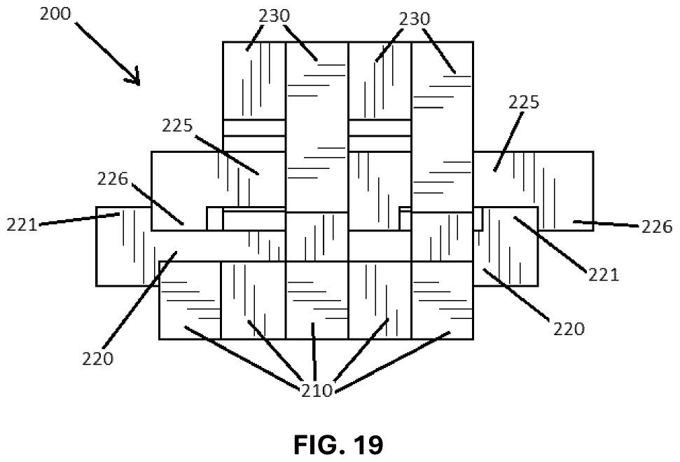

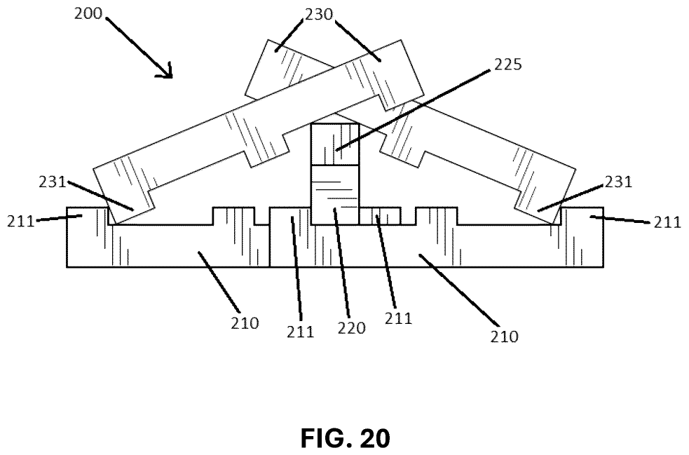

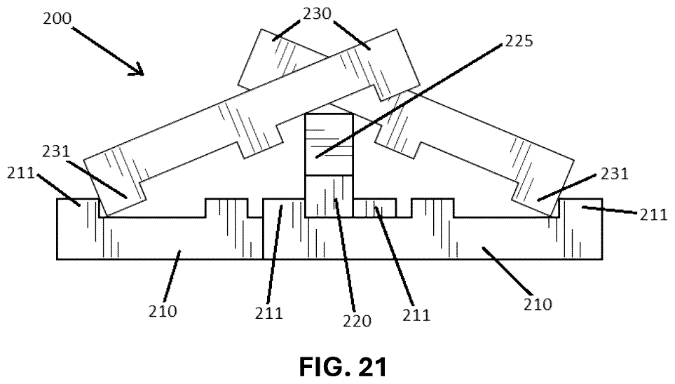

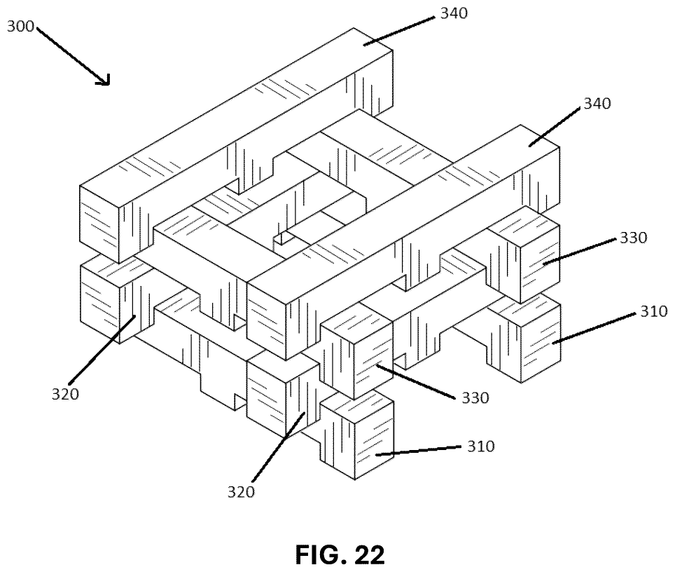

FIGS. 14-21 provide various views of one embodiment of the construction of a higher height sill (200) formed from a plurality of construction units of the present invention (as depicted individually in FIGS. 1-5). FIG. 14 shows a perspective top/side view of an embodiment of a high sill (200) assembled form a plurality of construction units (10) of the present invention. In this embodiment, the depicted section of the higher height sill (200) is formed from base units (210) arranged substantially parallel to one another and overlapping at one end with base units (210) protruding in the opposite direction, with all of the extensions (211) of the base units (210) directed in an upward direction. The ends of the alternately directed base units (210) overlap sufficiently that a first support unit (220) can be placed perpendicular to the base units (110) on top thereof, with the extensions (221) of first support unit (220) pointing in an upward direction, such that the support unit (220) sits on top of or between the extensions (211) at adjacent ends of the alternating base units (210). A second support unit (225) having its extensions (226) pointing in a downward direction, is placed atop first support unit (220) such that the extensions (226) of second support unit (225) and extensions (221) of first support unit (220) are interlaced to be adjacent one another along a linear direction of the first and second support units (220 and 225). Top units (230) are then placed with the extensions (231) pointing in a downward direction, such that one end rests on a base unit (210) abutted against an extension (211), and the other end rests on the second support unit (225) in an alternating fashion according to the arrangement of the base units (210). Due to the presence of two support units (220 and 225), this creates a steeper angle of the top units (230) and thus a higher sill structure (200) at its highest point. FIG. 15 shows an exploded perspective top/side view of the embodiment of high sill configuration of FIG. 14. FIG. 16 shows a top view of the embodiment of high sill (200) of FIG. 14. FIG. 17 shows a bottom view of the embodiment of high sill (200) of FIG. 14. FIG. 18 shows an exploded side view of the embodiment of high sill (200) of FIG. 14. FIG. 19 shows a front view of the embodiment of high sill (200) of FIG. 14. FIG. 20 shows a left side view of the embodiment of high sill (200) of FIG. 14. FIG. 21 shows a right side view of the embodiment of high sill (200) of FIG. 14.

In each of the low and high sill embodiments, the sill can be any lateral length desired, by continuing the configurations as depicted in FIGS. 6-21 through the addition of further base units, support units and top units on the ends of the depicted structures. Various shoreline shapes can be accommodated by varying the layout of the base units (and consequently how the top units are applied atop the base and support units) to follow the shoreline. Accordingly, the base units can be placed with angles between adjacent same side base unit pieces in order to curve the structure in either direction. Such adjustment is well within the skill level of one of ordinary skill in the art.

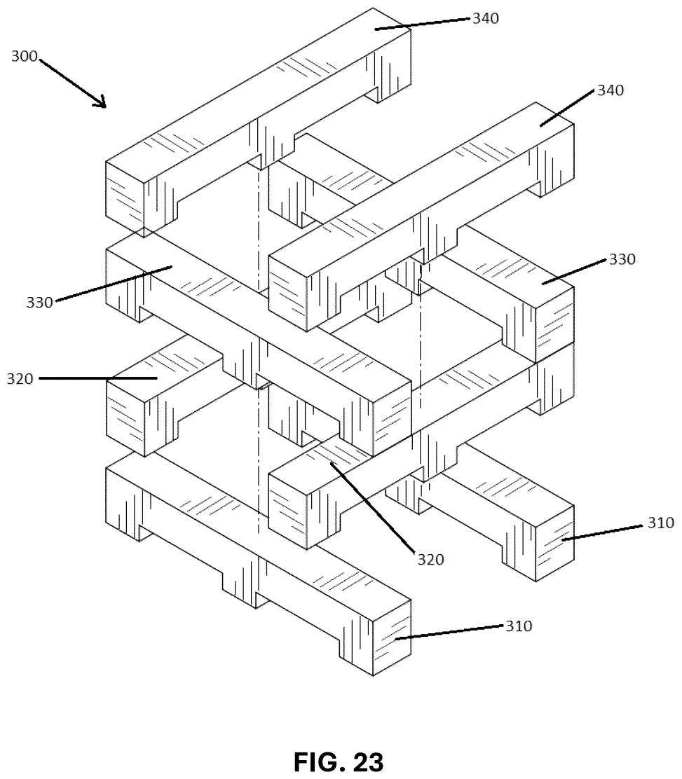

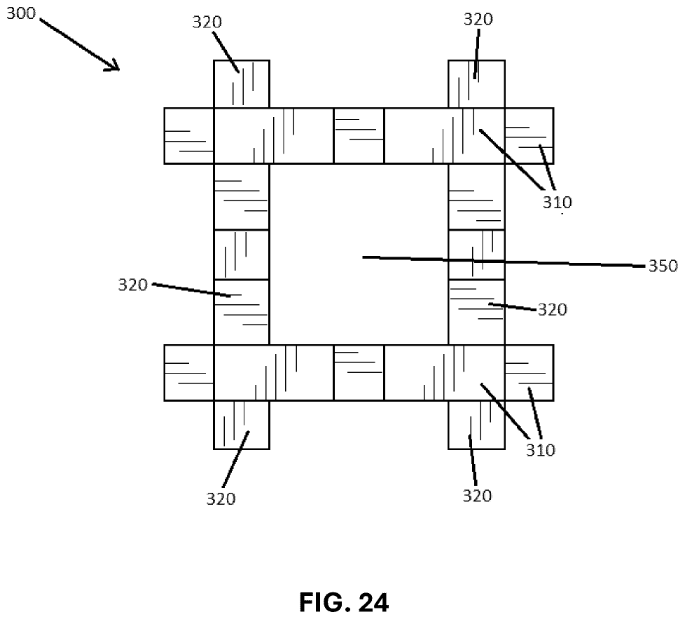

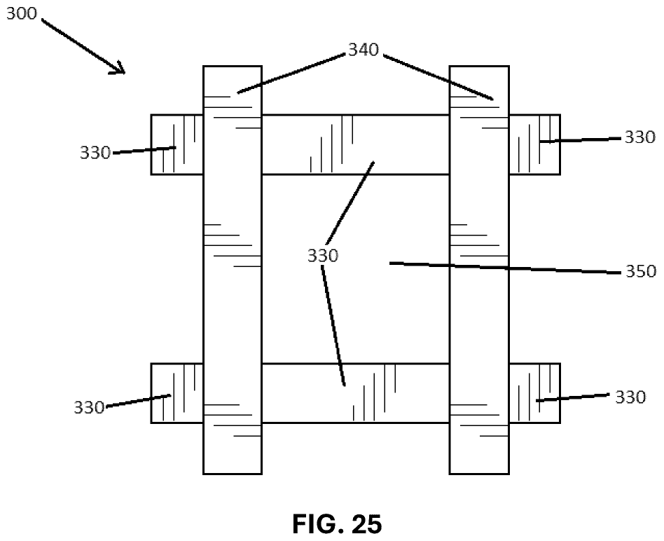

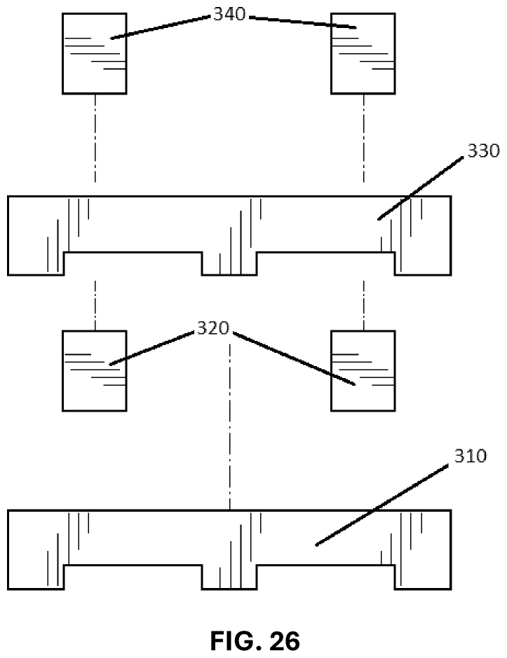

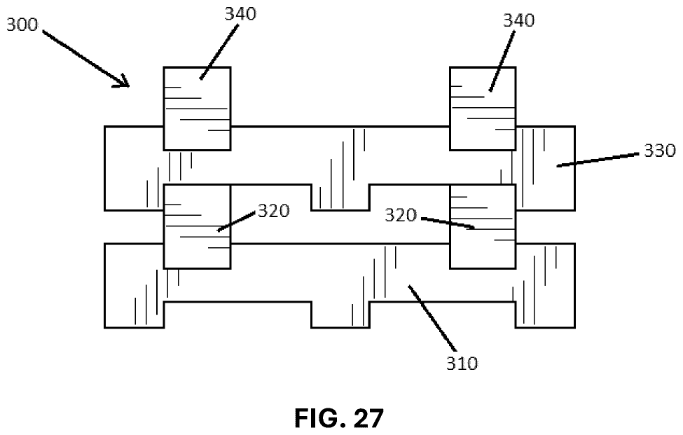

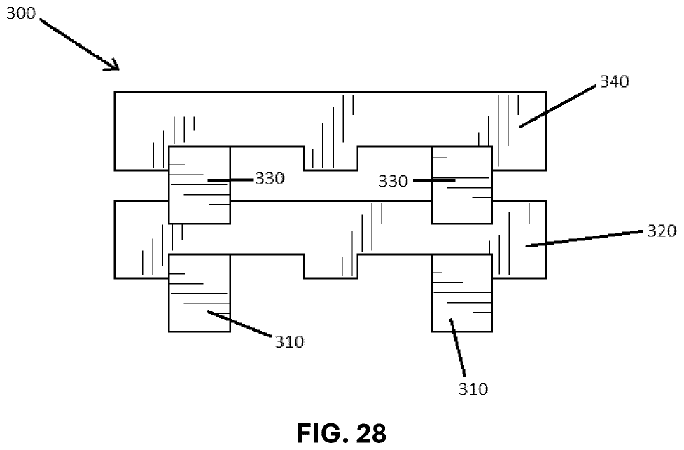

In a further embodiment of structure that can be constructed from a plurality of the construction units of the present invention, the structure can be a shoreline habitation structure. FIGS. 22-28 provide various views of an embodiment of a box shoreline habitation structure prepared from a plurality of construction units (10) (as shown in FIGS. 1-5). FIG. 22 shows a perspective top/side view of an embodiment of a box habitation unit (300) assembled from a plurality of construction units of the present invention. In this embodiment of the present invention, base units (310) are arranged parallel to one another at a distance such that a second layer of perpendicular cross pieces (320) can be placed thereon with the extensions at the end of each cross piece (320) fitting on the outside edge of each of the base units (310). These second layer of cross pieces (320) are thus parallel to one another at a distance such that a third layer of cross pieces (330) can be placed thereon and perpendicular to the second layer cross pieces (320) with the extensions at the end of each third layer cross piece (330) fitting on the outside edge of each of the second layer cross pieces (320). In FIG. 22, a fourth layer of cross pieces (340) is further depicted placed in an orientation similar to the second layer cross pieces (320). Depending on the desired height of the box habitation unit (300), this alternating layer structure can be repeated to achieve the desired height. The resulting structure provides a shoreline habitat zone for aquatic life to flourish between the openings created by the alternating layer structure and within the inner chamber created by the box nature. FIG. 23 shows an exploded perspective top/side view of the embodiment of box habitation unit (300) of FIG. 22. FIG. 24 shows a top view of the embodiment of box habitation unit (300) of FIG. 22. FIG. 25 shows a bottom view of the embodiment of box habitation unit (300) of FIG. 22. FIG. 26 shows an exploded side view of the embodiment of box habitation unit (300) of FIG. 22. FIG. 27 shows a view of the front (and back) of the embodiment of box habitation unit (300) of FIG. 22. FIG. 28 shows a view of the left (and right) side of the embodiment of box habitation unit (300) of FIG. 22. Due to the size and design of the construction units of the present invention, other types of habitation units can be readily constructed as well, and can be built to accommodate a variety of shoreline characteristics and terrains. Additionally, while the above description of FIGS. 22-28 uses the terms “left”, “right”, “front”, and “back”, these are merely for descriptive purposes, and the habitation structures can be constructed in any orientation desired. Further, while the description above uses the term “downward” to describe the direction that the extensions of the construction units are pointing, it is to be understood that the habitation structure can be constructed such that the extensions of the construction units point in any direction or a combination of directions, to provide more complex or alternative structures.

As used herein, the term “primarily calcium carbonate material” refers to rocks, clays, minerals, and, in certain embodiments, once living material from a living organism that produces portions of the organism that are primarily made up of calcium carbonate. Examples are limestone, marble, chalk, marl sand, marl aggregate, bird eggshells, and aquatic products. Included in aquatic products and aquatic shells are oysters, seashells, snail shells, pearls, coral, tufa, and the like. A collection of these materials is treated with cement in a mold to produce the desired shape, once the cement dries.

As used herein, the term “cement” refers to any biocompatible material, which can be used in certain embodiments as the cementitious material forming the restoration assembly module or its components, and preferably in certain embodiments to hold the primarily calcium carbonate material together in a slab form and be resistant to wave action, storms, and the like. An example includes, but is not limited to, portland cement. In one embodiment, the cement is a bio-cement compatible with the primarily calcium carbonate material, which has the capability of supporting growth on the construction units. An example includes quicklime made from oyster shells.

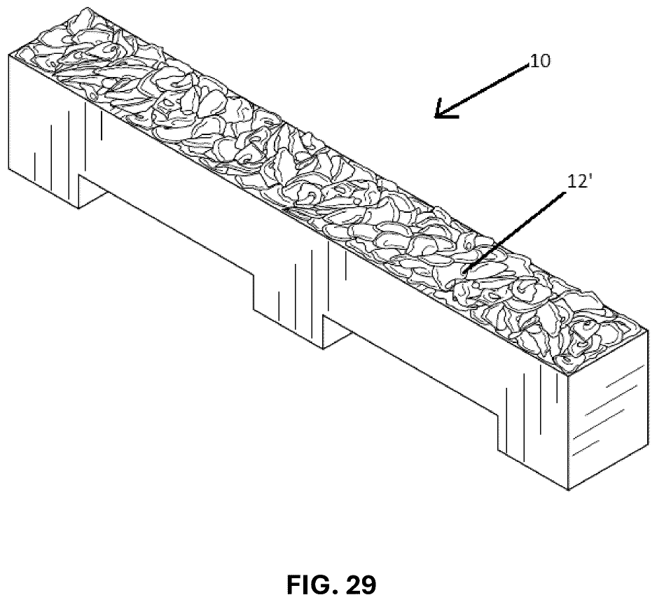

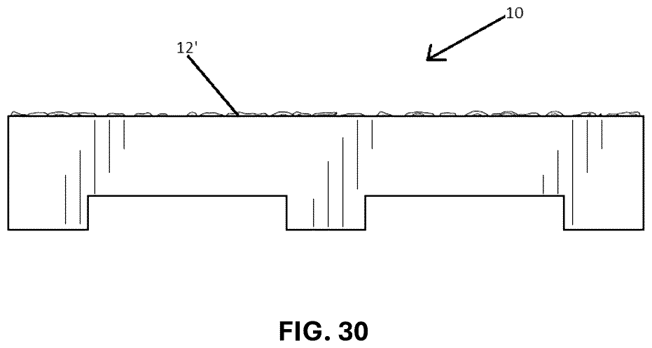

The construction units of the present invention may be made of virgin materials. In preferred embodiments, the construction units may be primarily made of calcium carbonate; i.e. marl sand, marl aggregate, oyster shell, and cement. The construction units may attract and grow oysters. Furthermore, the material that makes up the construction units may be local and native to coastal regions, thus making availability and production more efficient. This and other factors result in a better carbon footprint when constructing structures with the construction units of the invention. The construction units may contain rebar or other reinforcements if desired, but due to their size and weight, such reinforcements may not be necessary. It should be appreciated that FIGS. 1-28 are shown in a smooth pattern representing less of the primarily calcium carbonate materials in the composition. The construction units of the present invention may also contain primarily calcium carbonate material and preferably have one or more surfaces textured, having more of the primarily calcium carbonate materials in implementation. In a particularly preferred embodiment, the construction units (such as construction units (10) of FIGS. 1 and 2) have the primarily calcium carbonate materials forming a textured surface on the top face (12). However, any one or more of the faces or surfaces of the construction unit can be textured in such a manner as desired, and can provide higher surface area for aquatic life to flourish. FIG. 29 shows a perspective view of an example of the construction unit of FIG. 2 having the top face being a textured surface (12′) formed of the primarily calcium carbonate materials. FIG. 30 shows a side view of the construction unit of FIG. 29 having textured surface (12′) formed of primarily calcium carbonate materials.

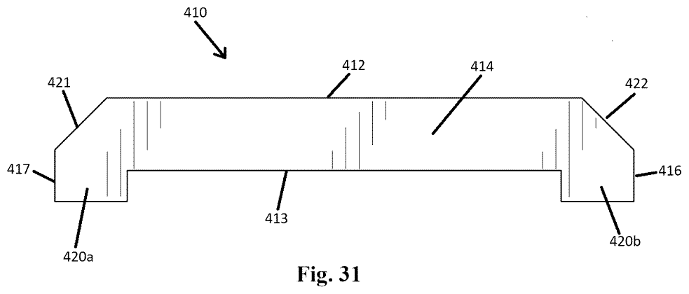

FIG. 31 shows a side view of another preferred embodiment of the construction unit of the invention, in which the construction unit (410) has a top face (412), a bottom face (413), a front face (414), and a back face (415, not shown), two end faces (416 and 417) and two or more extensions, two in the preferred embodiment shown in FIG. 31 (420a and 420b). Notable in this preferred embodiment is the angular faces (421) and (422) at each end of the construction unit (410), creating an angled face extending from top face (412) to side face (416) or (417). The angular faces (421) and (422) can be any desired angle between 0 and 90 degrees relative to top face (412), and is preferably between 30 and 60 degrees, most preferably approximately 45 degrees (within the context of the present invention, the phrase “approximately 45 degrees” is intended to include 45 degrees +/−2 degrees, or a range of 43-47 degrees). It is noted that while the terminology “top face”, “bottom face”, “front face” and “back face” are used herein, these terms are merely intended to differentiate between sides of the construction unit (410). The construction unit (410) can be placed in any desired orientation when using it to build structures, so that any side is on “top” or “bottom” in its final assembled structure.

While the construction units (410) can be any size, they are preferably of a size and weight suitable for handling and installation by an individual without the need for heavy machinery or other equipment. The construction unit (410) may preferably have a length from end face (416) to end face (417) ranging from 24 inches to 36 inches. The construction unit (410) may preferably have a thickness from front face (414) to back face (415) of from 3 inches to 6 inches. The construction unit (410) may preferably have a weight from 25 to 50 pounds. The construction unit (410) may preferably have a height from top face (12) to bottom face (413) (not including the extensions 420a and 420b) of from 3 inches to 6 inches. The total height of the construction unit (410) including the extensions (420a and 420b) may preferably be from 6 to 12 inches. Of course, depending on the size of ultimate assembly to be prepared, the size of the construction unit (410) can be scaled as desired, with larger units requiring machinery of various types to handle and install. Larger scale construction units (410) can be prepared and used to construct assemblies for installation in much deeper water environments

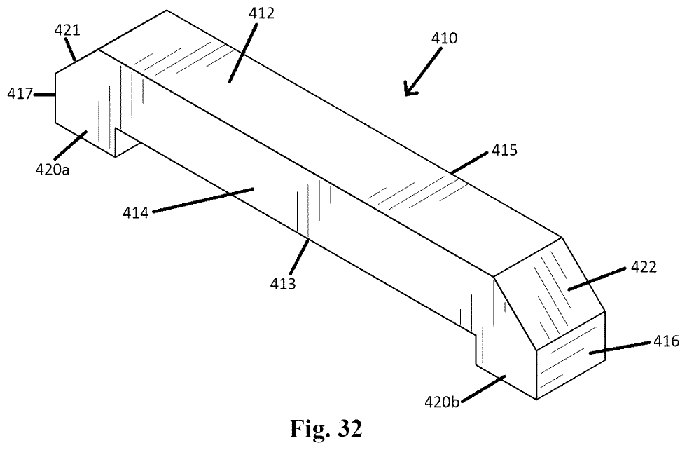

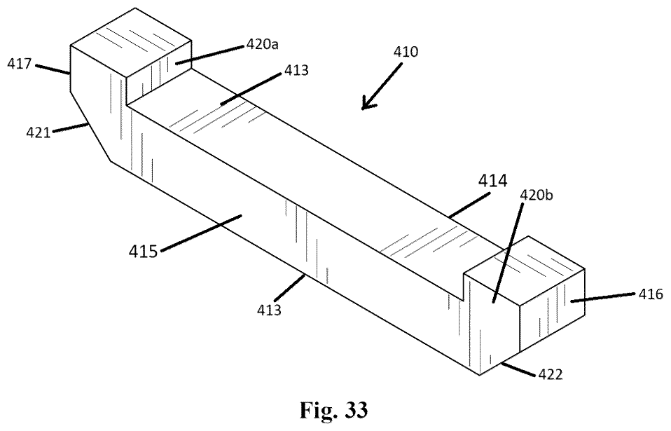

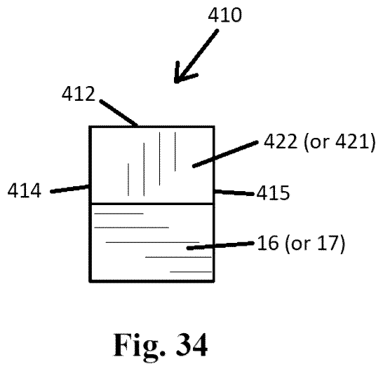

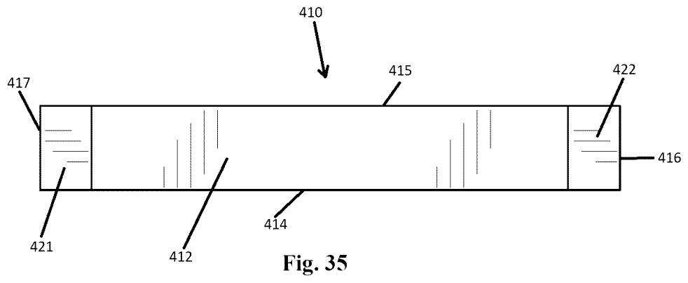

FIG. 32 shows a perspective top/side view of the embodiment of the embodiment of construction unit of FIG. 31. FIG. 33 shows a perspective bottom/side view of the embodiment of construction unit of FIG. 31. FIG. 34 shows an end view of the embodiment of construction unit of FIG. 31. FIG. 35 shows a top view of the embodiment of construction unit of FIG. 31.

Like the embodiments of FIGS. 1-5, the embodiments of construction units (410) of the present invention of FIGS. 31-35 may be made of virgin materials. In preferred embodiments, the construction units (410) may be primarily made of calcium carbonate; i.e. marl sand, marl aggregate, oyster shell, and cement. The construction units (410) may attract and grow oysters. Furthermore, the material that makes up the construction units (410) may be local and native to coastal regions, thus making availability and production more efficient. This and other factors result in a better carbon footprint when constructing structures with the construction units (410) of these embodiments of the invention. The construction units (410) may optionally contain rebar or other reinforcements if desired, but due to their size and weight, such reinforcements may not be necessary. It should be appreciated that FIGS. 31-35 are shown in a smooth pattern representing less of the primarily calcium carbonate materials in the composition. The construction units (410) of the present invention may also contain primarily calcium carbonate material and preferably have one or more surfaces textured, having more of the primarily calcium carbonate materials in implementation, particularly exposed on one or more surfaces thereof. The construction units (410) of the embodiments of FIGS. 31-35 can be prepared by a method similar to that used to prepare the construction units (110) of FIGS. 1-5, with the primary difference being the number of extensions (420a and 420b) present, and particularly the presence of the angular faces (421) and (422).

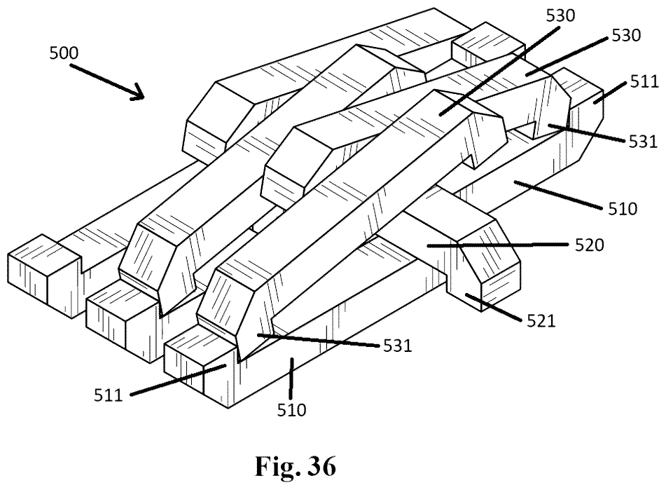

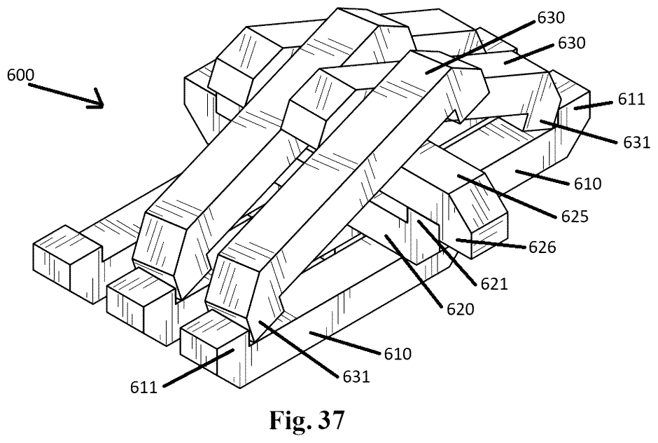

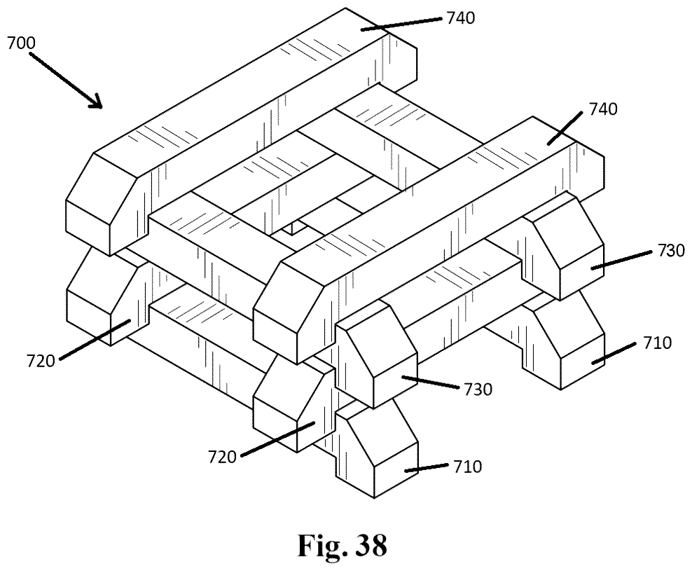

The construction units (410) of the embodiment of the present invention shown in FIGS. 31-35 can also be used to build a variety of structures useful in the protection of shoreline habitats and aquaculture. For example, and not intended to be limiting, a plurality of the construction units (410) can be configured to construct revetments, sills of various heights, artificial reefs, shore stabilization structures, wave attenuation structures, living shoreline habitats, and other semi-aquatic ecological restoration constructions. The structures that can be assembled using a plurality of construction units (410) of the present invention is limited only by the imagination of the person building the structure. By way of examples, FIG. 36 provides a view of an embodiment of a lower height sill structure similar to the structure of FIG. 6, but formed from a plurality of construction units (410) of FIGS. 31-35; FIG. 37 provides a view of an embodiment of a higher height sill structure, similar to the structure of FIG. 14, but formed from a plurality of construction units (410) of FIGS. 31-35; and FIG. 38 provides a view of an embodiment of a simple shoreline habitation structure similar to the structure of FIG. 22, but formed from a plurality of construction units (410) of FIGS. 31-35.

FIG. 36 provides a perspective top/side view of this embodiment of lower height sill structure (500) assembled from a plurality of construction units (410) of the present invention. In this embodiment, the depicted section of the lower height sill (500) is formed from base units (510) arranged substantially parallel to one another and overlapping at one end with base units (510) protruding in the opposite direction, with all of the extensions (511) of the base units (510) directed in an upward direction. The ends of the alternately directed base units (510) overlap sufficiently that a support unit (520) can be placed perpendicular to the base units (510) on top thereof, with the extensions (521) pointing in a downward direction, such that the support unit (520) sits on top of or between the extensions at adjacent ends of the alternating base units (510). Top units (530) are then placed with the extensions (531) pointing in a downward direction, such that one end rests on a base unit (510) abutted against an extension (511), and the other end rests on the support unit (520) in an alternating fashion according to the arrangement of the base units (510).

FIG. 37 shows a perspective top/side view of an embodiment of a high sill (600) assembled from a plurality of construction units (410) of the present invention. In this embodiment, the depicted section of the higher height sill (600) is formed from base units (610) arranged substantially parallel to one another and overlapping at one end with base units (610) protruding in the opposite direction, with all of the extensions (611) of the base units (610) directed in an upward direction. The ends of the alternately directed base units (610) overlap sufficiently that a first support unit (620) can be placed perpendicular to the base units (610) on top thereof, with the extensions (621) of first support unit (620) pointing in an upward direction, such that the support unit (620) sits on top of or between the extensions (611) at adjacent ends of the alternating base units (610). A second support unit (625) having its extensions (626) pointing in a downward direction, is placed atop first support unit (620) such that the extensions (626) of second support unit (625) and extensions (621) of first support unit (620) are interlaced to be adjacent one another along a linear direction of the first and second support units (620 and 625). Top units (630) are then placed with the extensions (631) pointing in a downward direction, such that one end rests on a base unit (610) abutted against an extension (611), and the other end rests on the second support unit (625) in an alternating fashion according to the arrangement of the base units (610). Due to the presence of two support units (620 and 625), this creates a steeper angle of the top units (630) and thus a higher sill structure (600) at its highest point.

FIG. 38 shows a perspective top/side view of an embodiment of a box habitation unit (700) assembled from a plurality of construction units (410) of the present invention. In this embodiment of the present invention, base units (710) are arranged parallel to one another at a distance such that a second layer of perpendicular cross pieces (720) can be placed thereon with the extensions at the end of each cross piece (720) fitting on the outside edge of each of the base units (710). These second layer of cross pieces (720) are thus parallel to one another at a distance such that a third layer of cross pieces (730) can be placed thereon and perpendicular to the second layer cross pieces (720) with the extensions at the end of each third layer cross piece (730) fitting on the outside edge of each of the second layer cross pieces (720). In FIG. 38, a fourth layer of cross pieces (740) is further depicted placed in an orientation similar to the second layer cross pieces (720). Depending on the desired height of the box habitation unit (700), this alternating layer structure can be repeated to achieve the desired height. The resulting structure provides a shoreline habitat zone for aquatic life to flourish between the openings created by the alternating layer structure and within the inner chamber created by the box nature.

The construction units of the present invention can be prepared by a variety of methods. In one embodiment, the present invention relates to a method of making the construction unit according to the present invention comprising:
a) providing a plurality of primarily calcium carbonate material;
b) placing the primarily calcium carbonate material in a mold structure (which can be formed of any desired material such as wood, plastic, composite materials, etc);
c) pouring a cement into the mold (and thus around and throughout the plurality of primarily calcium carbonate material) in a sufficient amount that when the cement hardens the construction unit (containing the cement and plurality of primarily calcium carbonate material) can be removed from the mold; and
d) removing the construction unit from the mold,
wherein the construction unit comprises a rectangular prism having two or more extensions extending from a long face of the rectangular prism, wherein a first two of the two or more extensions are located at opposite ends of the long face of the rectangular prism, and, when present, additional extensions are located between the first two of the plurality of extensions.

In an alternative embodiment, the construction units of the present invention can be prepared by a method comprising:
a) providing a mold structure (which can be formed of any desired material such as wood, plastic, composite materials, etc);
b) pouring a cementitious material into the mold in a sufficient amount that when the cement hardens the construction unit can be removed from the mold; and
c) removing the construction unit from the mold,
wherein the construction unit comprises a rectangular prism having two or more extensions extending from a long face of the rectangular prism, wherein a first two of the two or more extensions are located at opposite ends of the long face of the rectangular prism, and, when present, additional extensions are located between the first two of the plurality of extensions.

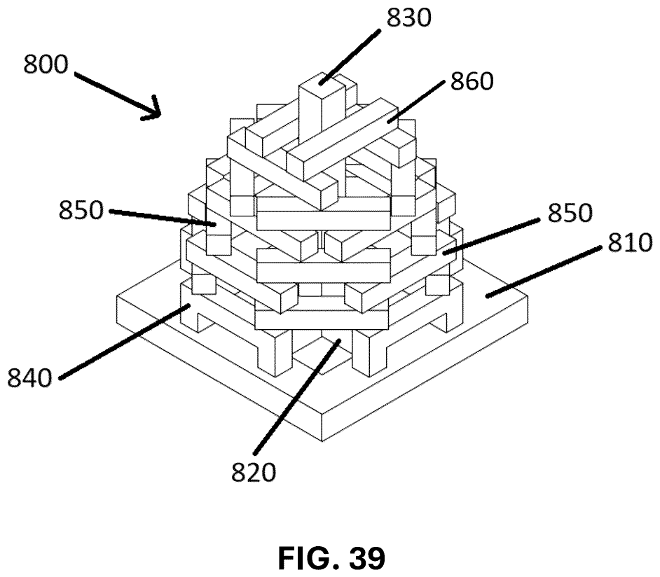

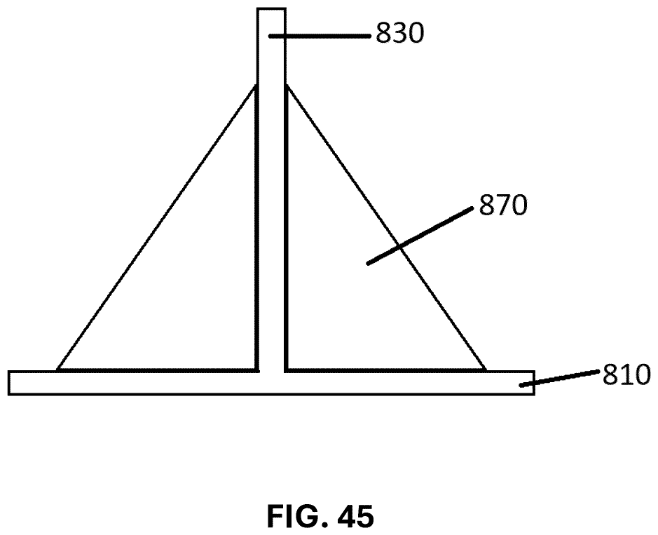

FIGS. 39-45 show one embodiment of habitat structure that can be prepared according to the present invention. FIG. 39 shows a perspective top/side view of this habitat structure (800). In this embodiment, the habitat structure (800) can be formed from a combination of construction units (840) of the invention along with units having a rectangular prism shape without any extensions (850), formed into a pyramidal shape having a plurality of sides, having a base structure (810) formed from the cementitious material, and having a solid perimeter around a plurality of sides of the base structure (810), with horizontal support structures (820) extending from an inner surface of each side to the middle. The habitat structure further comprises a vertical support structure (830), preferably having a rectangular prism shape. The vertical support structure (830) and the base structure (810) can be formed separately and be connected to one another via a cementitious material, or the combined base structure (810) and vertical support structure (830) can be formed as a unitary assembly. In certain embodiments as shown in FIG. 45, the vertical support structure (830) can have one or more stabilizing structures (870) extending from the sides thereof. These one or more stabilizing structures (870) are preferably triangular in shape, having one side fully contacting a vertical surface of the vertical support structure (830), one side fully contacting a horizontal support structure in the base (810), and the third side of the triangle angled from the vertical support structure to a point corresponding to the inner surface of the base structure perimeter. The base structure (810), vertical support structure (830), and optional one or more stabilizing structures (870) can be assembled and attached to one another using a cementitious material, or in preferred embodiments, the combined assembly of base structure (810), vertical support structure (830) and optional one or more stabilizing structures (870) can be formed as a unitary structure using an appropriately designed mold. In the latter case, the resulting structure will have more stability and strength, particularly for use in turbulent water environments.

In constructing the habitat structure (800) of this embodiment of the invention, a first level of construction units (840) are placed on a top surface of the base structure (810), where the first level of construction units (840) are preferably the construction units of the present invention having the two or more extensions extending from a long face of the rectangular prism, wherein these construction units (840) are placed such that the extensions are in contact with the base structure (810) and the rectangular prism body of the construction unit (840) is elevated from the base structure (810). Subsequent levels of the habitat structure are placed atop one another, such that one end of each unit (850) rests atop an end of a unit in the level just below, and the other end of each unit (850) rests atop an adjacent unit. In each subsequent level, this pattern is continued such that the resulting structure is an alternating pattern of units (850) having interstitial spaces therebetween. In certain embodiments, on each successive level, the units (850) are placed in such a manner that the overall dimensions of the level are smaller than the level on which it rests. In certain embodiments, this can be accomplished by placing the units (850) on the level below, such that the ends of adjacent units (850) are closer to one another than the corresponding ends of units (850) in the level on which they rest. The habitat structure can optionally be topped by levels of units (860) placed perpendicular to one another.

In assembling the habitat structure (800), the pieces are preferably assembled and cemented to one another in order to provide stability for the finished habitat structure (800). The finished habitat structure (800) can be placed in the desired location as a single structure using a crane or other suitable lifting and placement means.

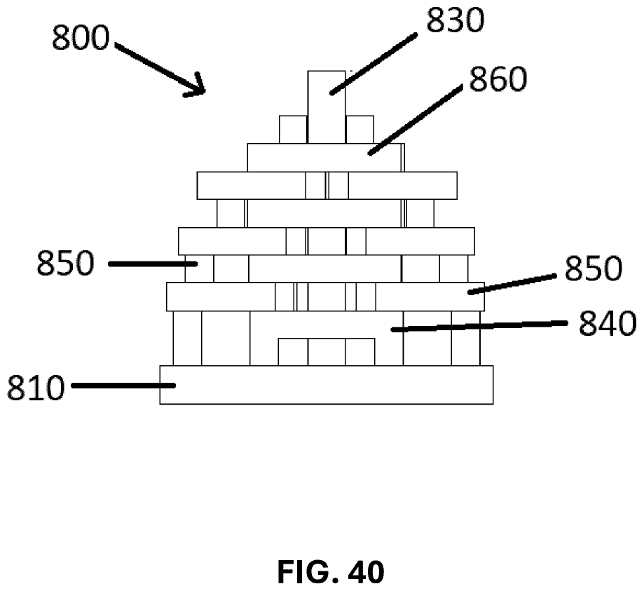

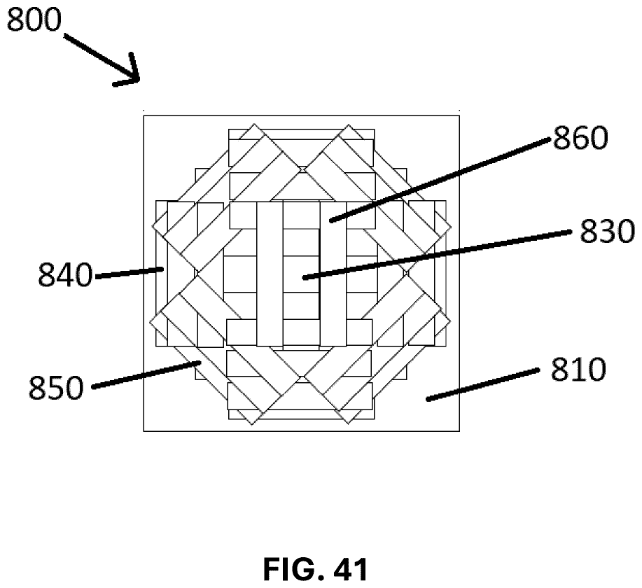

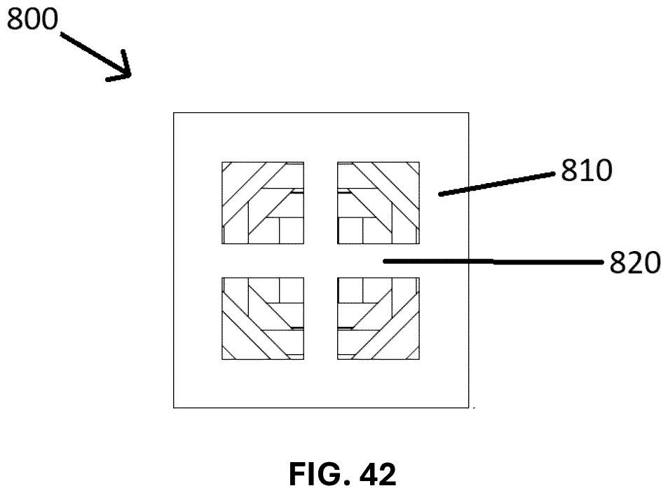

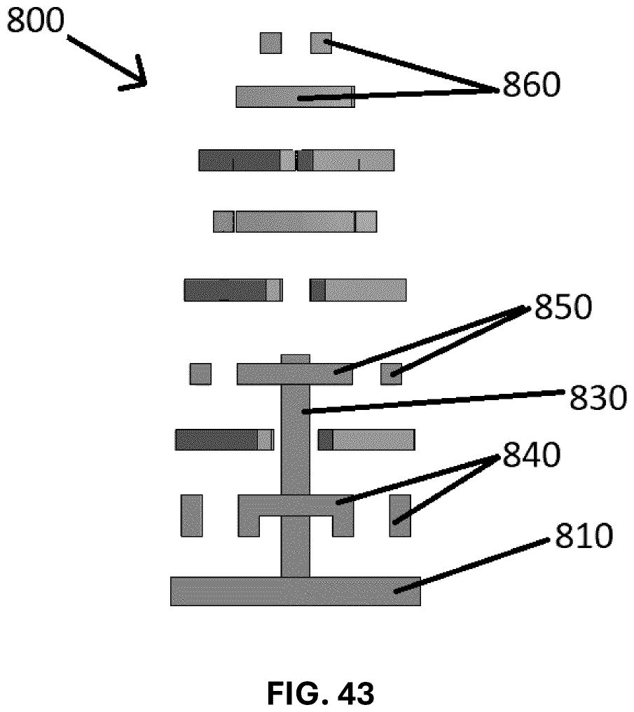

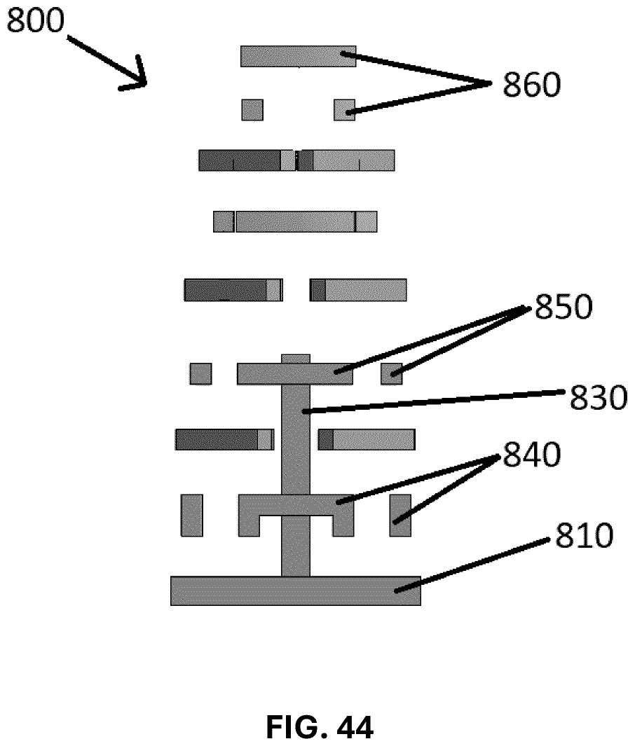

FIG. 40 shows a front view of the habitat structure (800) of one embodiment of the invention. FIG. 41 shows a top view of the habitat structure (800) of one embodiment of the invention. FIG. 42 shows a bottom view of the habitat structure (800) of one embodiment of the invention, in which it is easier to see the horizontal support structures (820) that form a part of base structure (810). FIG. 43 shows an exploded front or rear view of the habitat structure (800) of one embodiment of the invention. FIG. 44 shows an exploded right or left side view of the habitat structure (800) of one embodiment of the present invention.

The following is a non-exhaustive list of Embodiments of the present invention:

Embodiment 1. A construction unit for construction of eco-friendly structures in a body of water comprising:
a cementitious material;
wherein the construction unit comprises a rectangular prism having two or more extensions extending from a long face of the rectangular prism, wherein a first two of the two or more extensions are located at opposite ends of the long face of the rectangular prism, and, when present, additional extensions are located between the first two of the plurality of extensions.

Embodiment 2. The construction unit according to Embodiment 1, wherein the construction unit is of a size and weight suitable for handling and installation by an individual without a need for heavy machinery or other equipment.

Embodiment 3. The construction unit according to Embodiment 1, wherein the cementitious material comprises a primarily calcium carbonate material and a cement that is capable of holding the primarily calcium carbonate material.

Embodiment 4. The construction unit according to Embodiment 3, wherein the primarily calcium carbonate material is obtained from once living material from an organism.

Embodiment 5. The construction unit according to one of Embodiment 3 or Embodiment 4, wherein the primarily calcium carbonate material comprises aquatic shells.

Embodiment 6. The construction unit according to any one of Embodiments 3 to 5, wherein the cement is a io-cement.

Embodiment 7. The construction unit according to any one of Embodiments 1 to 6, wherein the construction unit has a length ranging from 24 inches to 36 inches.

Embodiment 8. The construction unit according to any one of Embodiments 1 to 7, wherein the construction unit has a total height, including the two or more extensions, ranging from 6 inches to 12 inches.

Embodiment 9. The construction unit according to any one of Embodiments 1 to 8, wherein the construction unit has a width ranging from 3 inches to 6 inches.

Embodiment 10. The construction unit according to any one of Embodiments 1 to 9, wherein the construction unit has a height, not including the two or more extensions, ranging from 3 inches to 6 inches.

Embodiment 11. The construction unit according to any one of Embodiments 1 to 10, wherein the construction unit has a weight ranging from 25 pounds to 50 pounds.

Embodiment 12. The construction unit according to any one of Embodiments 1-11, wherein the construction unit comprises a rectangular prism having two extensions extending from a first long face of the rectangular prism, wherein each of the two extensions are located at opposite ends of the long face of the rectangular prism, and wherein the rectangular prism has a second long face of the rectangular prism on an opposite side from the first long face, wherein the rectangular face has at each end an angular face extending from the second long face to an end face at an angle greater than 0 and less than 90 degrees relative to the second long face.

Embodiment 13. The construction unit according to Embodiment 12, wherein each angular face extends from the second long face to an end face at an angle from 30 to 60 degrees relative to the second long face.

Embodiment 14. The construction unit according to one of Embodiment 12 or Embodiment 13, wherein each angular face extends from the second long face to an end face at an angle of approximately 45 degrees relative to the second long face.

Embodiment 15. A method of making the construction unit according to any one of Embodiments 1 to 14 comprising:

a) providing a plurality of primarily calcium carbonate material;
b) placing the primarily calcium carbonate material in a mold structure;
c) pouring the cement into the mold in a sufficient amount that when the cement hardens the construction unit can be removed from the mold; and
d) removing the construction unit from the mold,
wherein the construction unit comprises a rectangular prism having two or more extensions extending from a long face of the rectangular prism, wherein a first two of the two or more extensions are located at opposite ends of the long face of the rectangular prism, and, when present, additional extensions are located between the first two of the plurality of extensions.

Embodiment 16. The method according to Embodiment 15, wherein the construction unit is of a size and weight suitable for handling and installation by an individual without a need for heavy machinery or other equipment.

Embodiment 17. The method according to Embodiment 16, wherein the primarily calcium carbonate material is obtained from once living material from an organism.

Embodiment 18. The method according to one of Embodiment 16 or Embodiment 17, wherein the primarily calcium carbonate material is aquatic shells.

Embodiment 19. The method according to any one of Embodiments 16 to 18, wherein the cement is a bio-cement.

Embodiment 20. The method according to any one of Embodiments 15 to 19, wherein the construction unit has a length ranging from 24 inches to 36 inches.

Embodiment 21. The method according to any one of Embodiments 15 to 20, wherein the construction unit has a total height, including the two or more extensions, ranging from 6 inches to 12 inches.

Embodiment 22. The method according to any one of Embodiments 15 to 21, wherein the construction unit has a width ranging from 3 inches to 6 inches.

Embodiment 23. The method according to any one of Embodiments 15 to 22, wherein the construction unit has a height, not including the two or more extensions, ranging from 3 inches to 6 inches.

Embodiment 24. The method according to any one of Embodiments 15 to 23, wherein the construction unit has a weight ranging from 25 pounds to 50 pounds.

Embodiment 25. A shoreline stabilization structure formed from a plurality of construction units according to any one of Embodiments 1 to 14.

Embodiment 26. An artificial reef structure formed from a plurality of construction units according to any one of Embodiments 1 to 14.

Embodiment 27. A revetment structure formed from a plurality of construction units according to any one of Embodiments 1 to 14.

Embodiment 28. A sill formed from a plurality of construction units according to any one of Embodiments 1 to 14.

Embodiment 29. A shoreline habitation unit formed from a plurality of construction units according to any one of Embodiments 1 to 14.

Embodiment 30. A method of making the construction unit according to any one of Embodiments 1 to 14 comprising:
a) providing a mold structure;
b) pouring the cementitious material into the mold in a sufficient amount that when the cement hardens the construction unit can be removed from the mold; and
c) removing the construction unit from the mold,
wherein the construction unit comprises a rectangular prism having two or more extensions extending from a long face of the rectangular prism, wherein a first two of the two or more extensions are located at opposite ends of the long face of the rectangular prism, and, when present, additional extensions are located between the first two of the plurality of extensions.

Embodiment 31. The method according to Embodiment 30, wherein the construction unit is of a size and weight suitable for handling and installation by an individual without a need for heavy machinery or other equipment.

Embodiment 32. The method according to one of Embodiment 30 or Embodiment 31, wherein the construction unit has a length ranging from 24 inches to 36 inches.

Embodiment 33. The method according to any one of Embodiments 30 to 32, wherein the construction unit has a total height, including the two or more extensions, ranging from 6 inches to 12 inches.

Embodiment 34. The method according to any one of Embodiments 30 to 33, wherein the construction unit has a width ranging from 3 inches to 6 inches.

Embodiment 35. The method according to any one of Embodiments 30 to 34, wherein the construction unit has a height, not including the two or more extensions, ranging from 3 inches to 6 inches.

Embodiment 36. The method according to any one of Embodiments 30 to 35, wherein the construction unit has a weight ranging from 25 pounds to 50 pounds.

Embodiment 37. A habitat structure comprising:
(i) a base structure having a perimeter and one or more horizontal support structures extending from a first inner side of the perimeter to an opposite second inner side of the perimeter;
(ii) a vertical support structure extending from a centerpoint of the base structure to a desired height;
(iii) a plurality of construction units of claim 1 placed around the top surface of the perimeter of the base structure, having a first gap between each two adjacent construction units and resting on the two or more extensions of the construction unit;
(iv) a first plurality of cementitious units placed atop the plurality of construction units of part (iii), such that a first end of a cementitious unit rests atop one construction unit and a second end of the cementitious unit rests atop an adjacent construction unit spanning the first gap, until each gap formed between each two adjacent construction units is spanned by one of the plurality of cementitious units, and there is a second gap between each pair of adjacent first plurality of cementitious units;
(v) a second plurality of cementitious units placed atop the first plurality of cementitious units such that a first end of a cementitious unit rests atop one cementitious unit of the first plurality of cementitious units and a second end of the cementitious unit rests atop an adjacent cementitious unit of the first plurality of cementitious units spanning the second gap therebetween, until each second gap formed between each two adjacent first plurality of cementitious units is spanned by one of the second plurality of cementitious units, and there is a third gap between each pair of adjacent second plurality of cementitious units;
(vi) repeating step (v) until a desired height is attained.

Embodiment 38. The habitat structure of Embodiment 37, wherein pieces of the habitat structure are adhered one to another using a cementitious material.

Embodiment 39. The habitat structure of Embodiment 37 or Embodiment 38, further comprising one or more stabilization structures for stabilizing the vertical support structure relative to the base structure.

Embodiment 40. The habitat structure of Embodiment 37, wherein the base structure and vertical support structure are formed as a unitary structure.

Embodiment 41. The habitat structure of Embodiment 39, wherein the base structure, vertical support structure, and one or more stabilization structures are formed as a unitary structure.

Obviously, numerous modifications and variations of the present invention are possible in light of the above teachings. It is therefore to be understood that within the scope of the appended claims, the invention may be practiced otherwise than as specifically described herein.

What is claimed is:

1. A construction unit for construction of eco-friendly structures in a body of water comprising:
a cementitious material;
wherein the construction unit comprises a rectangular prism having two or more extensions extending from a long face of the rectangular prism, wherein a first two of the two or more extensions are located at opposite ends of the long face of the rectangular prism, and, when present, additional extensions are located between the first two of the plurality of extensions.

2. The construction unit according to claim 1, wherein the construction unit is of a size and weight suitable for handling and installation by an individual without a need for heavy machinery or other equipment.

3. The construction unit according to claim 1, wherein the cementitious material comprises a primarily calcium carbonate material and a cement that is capable of holding the primarily calcium carbonate material.

4. The construction unit according to claim 3, wherein the primarily calcium carbonate material is obtained from once living material from an organism.

5. The construction unit according to claim 3, wherein the primarily calcium carbonate material comprises aquatic shells.

6. The construction unit according to claim 3, wherein the cement is a bio-cement.

7. The construction unit according to claim 1, wherein the construction unit comprises a rectangular prism having two extensions extending from a first long face of the rectangular prism, wherein each of the two extensions are located at opposite ends of the long face of the rectangular prism, and wherein the rectangular prism has a second long face of the rectangular prism on an opposite side from the first long face, wherein the rectangular face has at each end an angular face extending from the second long face to an end face at an angle greater than 0 and less than 90 degrees relative to the second long face.

8. The construction unit according to claim 7, wherein each angular face extends from the second long face to an end face at an angle from 30 to 60 degrees relative to the second long face.

9. The construction unit according to claim 7, wherein each angular face extends from the second long face to an end face at an angle of approximately 45 degrees relative to the second long face.

10. A method of making the construction unit according to claim 1, comprising:
a) providing a plurality of primarily calcium carbonate material;
b) placing the primarily calcium carbonate material in a mold structure;
c) pouring the cement into the mold in a sufficient amount that when the cement hardens the construction unit can be removed from the mold; and
d) removing the construction unit from the mold,
wherein the construction unit comprises a rectangular prism having two or more extensions extending from a long face of the rectangular prism, wherein a first two of the two or more extensions are located at opposite ends of the long face of the rectangular prism, and, when present, additional extensions are located between the first two of the plurality of extensions.

11. The method according to claim 10, wherein the construction unit is of a size and weight suitable for handling and installation by an individual without a need for heavy machinery or other equipment.

12. The method according to claim 11, wherein the primarily calcium carbonate material is obtained from once living material from an organism.

13. The method according to claim 11, wherein the primarily calcium carbonate material is aquatic shells.

14. The method according to claim 10, wherein the cement is a bio-cement.

15. A shoreline stabilization structure, artificial reef structure, revetment structure, sill structure, or shoreline habitation unit formed from a plurality of construction units according to claim 1.

16. A method of making the construction unit according to claim 1, comprising:
a) providing a mold structure;
b) pouring the cementitious material into the mold in a sufficient amount that when the cement hardens the construction unit can be removed from the mold; and
c) removing the construction unit from the mold,
wherein the construction unit comprises a rectangular prism having two or more extensions extending from a long face of the rectangular prism, wherein a first two of the two or more extensions are located at opposite ends of the long face of the rectangular prism, and, when present, additional extensions are located between the first two of the plurality of extensions.

17. The method according to claim 16, wherein the construction unit is of a size and weight suitable for handling and installation by an individual without a need for heavy machinery or other equipment.

18. A habitat structure comprising:
(i) a base structure having a perimeter and one or more horizontal support structures extending from a first inner side of the perimeter to an opposite second inner side of the perimeter;
(ii) a vertical support structure extending from a centerpoint of the base structure to a desired height;
(iii) a plurality of construction units of claim 1 placed around the top surface of the perimeter of the base structure, having a first gap between each two adjacent construction units and resting on the two or more extensions of the construction unit;
(iv) a first plurality of cementitious units placed atop the plurality of construction units of part (iii), such that a first end of a cementitious unit rests atop one construction unit and a second end of the cementitious unit rests atop an adjacent construction unit spanning the first gap, until each gap formed between each two adjacent construction units is spanned by one of the plurality of cementitious units, and there is a second gap between each pair of adjacent first plurality of cementitious units;
(v) a second plurality of cementitious units placed atop the first plurality of cementitious units such that a first end of a cementitious unit rests atop one cementitious unit of the first plurality of cementitious units and a second end of the cementitious unit rests atop an adjacent cementitious unit of the first plurality of cementitious units spanning the second gap therebetween, until each second gap formed between each two adjacent first plurality of cementitious units is spanned by one of the second plurality of cementitious units, and there is a third gap between each pair of adjacent second plurality of cementitious units;
(vi) repeating step (v) until a desired height is attained.

19. The habitat structure of claim 18, wherein pieces of the habitat structure are adhered one to another using a cementitious material.

20. The habitat structure of claim 18, further comprising one or more stabilization structures for stabilizing the vertical support structure relative to the base structure.

21. The habitat structure of claim 18, wherein the base structure and vertical support structure are formed as a unitary structure.

22. The habitat structure of claim 20, wherein the base structure, vertical support structure, and one or more stabilization structures are formed as a unitary structure.
